(19) United States
(12) Patent Application Publication
(10) Pub. No.: US 2026/0323677 A1
(43) Pub. Date: Oct. 15, 2026

(54) METHOD AND SYSTEM FOR RANDOM ACCESS IN 5G

(71) Applicant: Continental Automotive Technologies GmbH, Hannover (DE)

(72) Inventors: David Gonzalez Gonzalez, Egelsbach (DE); Rikin Shah, Langen (DE)

(73) Assignee: Continental Automotive Technologies GmbH, Hannover (DE)

(21) Appl. No.: 19/101,100

(22) PCT Filed: Aug. 3, 2023
(86) PCT No.: PCT/EP2023/071565

§ 371 Date: Feb. 4, 2025

(30) Foreign Application Priority Data
Aug. 4, 2022 (DE) 10 2022 208 149.8

(51) Int. Cl. H04W 72/542; H04L 5/00; H04W 72/02; H04W 74/0833

(52) U.S. Cl. CPC H04W 72/542; H04L 5/0042; H04L 5/0094; H04W 72/02; H04W 74/0833

(57) ABSTRACT

Random access is performed of a mobile user equipment to a wireless communication network especially according to 5G standard especially when working in frequency bands above 24 GHz. The UE monitors the quality, especially the received power, of Synchronization Signal Blocks and selects an SSB with quality above a network configured threshold TH_{C} for transmitting a preamble in a corresponding nominal RACH Occasion using the respective beam. In case UE could not find an SSB with quality above the threshold TH_{C}, the UE selects an SSB with quality below TH_{C} for transmitting a preamble in a corresponding RACH occasion using the respective beam and selects an additional SSB for transmitting the preamble in a “mirror” RACH occasion located on a “mirror” frequency of a different beam.

### CROSS-REFERENCE TO RELATED APPLICATIONS

The present application is a National Stage Application under 35 U.S.C. § 371 of International Patent Application No. PCT/EP2023/071565 filed on Aug. 3, 2023, and claims priority from German Patent Application No. 10 2022 208 149.8 filed on Aug. 4, 2022, in the German Patent and Trademark Office, the disclosures of which are herein incorporated by reference in their entireties.

### TECHNICAL FIELD

The application generally relates to wireless communication and, more particularly, to the random access procedure in a 5G telecommunication system, especially working in Frequency Range 2 (FR2), i.e. mmWave region above 24 GHz. More specifically, the application relates to random access (RA) of a mobile user equipment (UE) to a wireless communication network according to 5G or a beyond 5G standard, especially when working in frequency bands above 24 GHz. For random access, the UE monitors the quality, especially the received power (RSRP), of Synchronization Signal Blocks (SSBs) and selects an SSB with quality above a network configured threshold TH_{C} for transmitting a preamble in a corresponding nominal RACH Occasion (RO) using the respective beam.

### BACKGROUND

When a user equipment (UE) intents communication with the network, first it performs some cell search and selection procedures for obtaining initial cell synchronization and system information. During frame synchronization, the UE finds the cell identity, decodes MIB and SIB1 and reads the synchronization signal block (SSB). In case of a multi-antenna system transmitting multiple beams, the UE detects some of the beams/SSBs transmitted by the gNB. Doing that, UE measures beam strength by measuring received signal power, whereby it searches for the best beam using a predefined threshold criterion defined by the network. The UE selects the best beam which is identified by the highest reference signal received power (RSRP).

After the UE has selected a beam, it uses an interval of the random-access channel (RACH) to transmit a RACH preamble on that physical RACH (PRACH) which corresponds to the SSB for which the best beam was identified. For transmitting the RACH preamble, an area specified in time and frequency domain called RACH Occasion (RO) is available. Thereby, the system provides an association between the SSBs transmitted by the gNB and the RO to be used to perform Random Access.

As mentioned, in 5G New Radio (NR) the sync signal (SSB) may be associated with different beams and UE selects a certain beam for initiating the random access using the corresponding beam in uplink direction. In order for network to figure out which beam UE has selected, 3GPP defines a specific mapping between SSB and RACH Occasion. By detecting which RO has used, the network can figure out which SSB beam was selected by UE.

The mapping between SSB and RACH Occasion is defined by the following RRC parameters “msg1-FDM” specifying how many RO are allocated in frequency domain (at the same location in time domain) and “ssb-perRACH-OccasionAndCB-PreamblesPerSSB”, specifying how many SSB can be mapped to one RO and how many preamble indexes can be mapped to single SSB.

The overall mapping logic is described in TS 38.213-8.1 and listed below:
First, in increasing order of preamble indexes within a single PRACH occasion,
Second, in increasing order of frequency resource indexes for frequency multiplexed PRACH occasions
Third, in increasing order of time resource indexes for time multiplexed PRACH occasions within a PRACH slot. Fourth, in increasing order of indexes for PRACH slots

From that, a scenario where all SSBs are detected with poor quality, i.e. RSRP below a certain threshold, is actually likely to happen especially in FR2. Current 5G specifications indicate UE to perform random access in the best beam. UE is not expected to perform random access in other RACH resources; possibly at later points in time until resolution of the current attempt.

Especially when operating in high frequencies, e.g., in mmWave region above 24 GHz, it is possible that the whole set of best beams including the best N beams have poor quality. In such circumstances, the possibility that MSG1 is not properly received is high, even after several attempts with progressive Tx power increments. This increases (access) latency and delays the access to the network.

It might be considered to send multiple random access to improve the probability of successful receipt of MSG1 whereby there are at least the following two thinkable possibilities of sending multiple MSG1: First is a sequential sending by using different ROs. This might be feasible but is not allowed in 5G. The other is parallel sending. This is not possible even with digital beamforming as RO are time multiplexed.

The object of the invention is to improve the probability of successful transmission of MSG1 and to improve random access (RA).

The invention is described by the features of the independent claims 1, 10, 13 and 16. Advantageous embodiments could be found in the respective subclaims.

### BRIEF SUMMARY

As could be seen from the main claims, the inventive idea becomes relevant in case of bad channel quality. In normal case, when a UE receives SSB, for example SSB1, with good quality, it should send the MSG1 using the nominal RO in the corresponding timeslot (e.g. t1) at corresponding frequency (e.g. f1) as associated to SSB (e.g. SSB1). But, if each SSB received by the UE has bad quality, i.e. with quality below a defined threshold, it is proposed that UE sends parallel access attempts, especially by MSG1, with the same pre-configured preamble on multiple beams. In order to allow such multiple (more than one) MSG1s, the inventive idea introduces the so-called “mirror ROs”, which can also be used with the rule that mirror RO are used for beams (SSBs) which are different to the ones associated to the nominal RO happening at any given time. Therefore, in the first mirror RO happening at the same time that of nominal RO the UE can only reply using a beam different than SSB1.

By that, the invention introduces a physical channel structure and a random-access procedure to give more reliability to the MSG1, in a 5G-compatible or in a beyond 5G manner. The inventive solution assumes the possibility on transmitting multiple beams at the same time, especially by using digital beamforming.

As described above and as outlined in the claims, the invention applies to the situation that the UE could not find an SSB with a quality above the defined threshold TH_{C}. In that case, the UE selects first a SSB with quality below the TH_{C} and transmits a preamble in a corresponding (nominal) RACH occasion (RO) using the respective beam. Besides, UE selects an additional SSB and transmits the same preamble in the “mirror RACH Occasion” located on a “mirror” frequency of a different beam. Thereby the “mirror RO” happens in the same time slot as the nominal ROs, but in a different (“mirror”) frequency resource.

In other words, the UE monitors SSBs and if the quality of all SSBs are below a network configured threshold TH_{C} the UE selects a pre-configured preamble and transmits MSG1 in more than one selected beams with a quality below the threshold TH_{C}. Since current 5G specifications indicate that UE should perform random access in the best beam, the inventive solution allows UE to perform random access in other RACH. So, the proposed solution introducing the concept of mirror RACH Occasion (“mirror RO”) creates the possibility for UE with the capability of simultaneous transmissions over multiple beams to leverage the spatial diversity. The solution also exploit frequency diversity and is backward compatible, i.e., it is transparent to “legacy UE”.

For establishing access of a UE to a wireless communication system, gNB and/or by wireless communication system network might pre-configure the random access occasions (ROs). For that, the gNB or the wireless communication network might indicate which ROs are to be used by default and which ones for special events and when triggered by a prediction event. In an advantageous embodiment of the invention, gNB/network explicitly indicates the location of mirror RO as System Information and defines a frequency resource within the initial Bandwidth Part (BWP) matching the nominal RACH Occasion of each SSB. With that, the gNB respectively the network explicitly indicates which resources to be use for random access and the mirror frequency f_{Mirr} is set to Mirror RO. In an advantageous embodiment, the gNB determines to use part of the radio spectrum originally assigned for wireless communications for radar usage, especially the radio band of 400 MHz.

Additionally, it is advantageous to define set of pre-configured preambles to use for the proposed parallel RACH. Thereby, if UE cannot find a SSB with power above TH_{C}, the preamble is a pre-configured (marked) preamble signaled or indicated by the base station (gNB). UE should use the same preamble for RA in the mirror RO, whereby the UE may use mirror ROs to send the preamble using any beam except the nominal one defined at that time slot. When gNB receives such a marked preamble in the nominal RO it recognizes that there should be one or more (number M) further preambles in respective mirror ROs.

The number M of multiple beams which are send parallel at the same time, especially by using digital beamforming, might be defined by a rule implemented in the UE. In that case, UE has a certain rule (e.g., table, formula) that tells how many parallel beams (M) to use to transmit the MSG1 based on the quality of the received ones. In an advantageous embodiment the rule defines M=f (N, TH₀), i.e., in dependency of a threshold TH₀ and of the variable N corresponding to the number of SSBs with a power between a defined TH_{S} and TH₀. Thereby TH_{S} is the minimum power where detection is possible and TH₀ is defined by the system, whereby TH_{S}≤TH₀<TH_{C}. In a preferred embodiment, the values of TH₀ and/or Nare given by the system information or are hard-coded in the specification to be known by all participants of the communication system.

The various steps of the claimed methods could be performed by instructions of computer programs. Consequently, the invention further refers to respective computer programs on an information medium. These programs being suitable to be implemented respectively in user equipment device and a base station, or more generally in a computer. These programs respectively comprising instructions adapted to implement the steps of the inventive methods respectively supported by a user equipment and performed by a base station disclosed herein. The programs can use any programming language, and be in the form of source code, object code, or of code intermediate between source code and object code, such as in a partially compiled form, or in any other desirable form.

A further aspect relates to an information medium readable by a computer comprising instructions of a computer program such as mentioned hereinabove. The information medium may be any entity or device capable of storing the program. For example, the medium can comprise a storage means, such as a ROM (Read Only Memory), for example a CD ROM or a microelectronic circuit ROM, EEPROM (Electrically Erasable Programmable Read-Only Memory), FLASH memory or any magnetic recording means, for example a hard drive. Moreover, the information medium may be a transmissible medium such as an electrical or optical signal, which may be conveyed via an electrical or optical cable, by radio or by other means. The program according to an embodiment of the invention may be downloaded from a network. Alternatively, the information medium may be an integrated circuit into which the program is incorporated, the circuit being arranged to execute or to be used in the execution of the methods in question.

### BRIEF DESCRIPTION OF THE DRAWINGS

Other advantages and characteristics of the invention will be more clearly apparent on reading the following description, given by way of simple illustrative and non-limiting example, and the appended drawings

FIG. 1 illustrates mirror ROs which can be used to send the (marked) preamble using any beam except the nominal one defined at that time slot.

FIG. 2 shows how gNB indicates the location of mirror ROs defined as a frequency resource matching the nominal RACH Occasion of each SSBs.

FIG. 3 shows a flow chart including mains steps of a state machine suitable to proceed parallel MSG-1 on multiple beams on UE-side.

FIG. 4 is a flow chart showing mains steps of a state machine suitable to proceed parallel MSG-1 on multiple beams on gNB-side.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

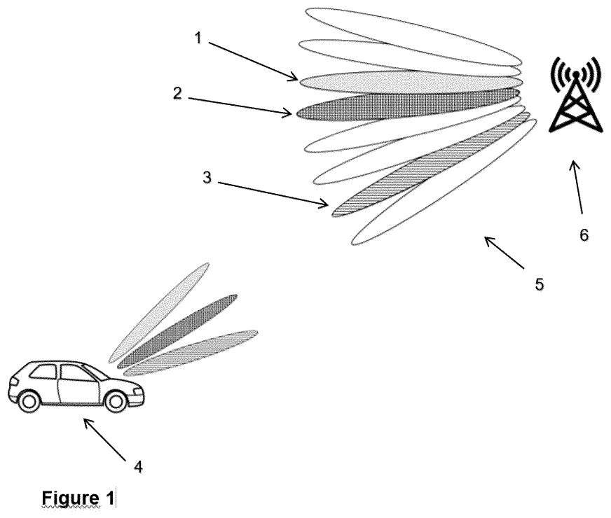

FIG. 1 illustrates the concept of mirror ROs which can be used to send the (marked) preamble using any beam except the nominal one defined at that time slot. In the illustrated example, a UE implemented in a car 4 monitors quality of a couple of SSBs 5 submitted by the gNB 6 according to the standardized specification and functionality. In the example, none of the SSBs' has a power (Reference Signal Received Power, RSRP) above the network-configured threshold (TH_{C}). This is possible and likely in FR2 scenarios. From the couple of SSBs, three SSBs 1, 2 and 3 can be detected by the UE with a quality below threshold, but with a sufficient quality. The rest of the beams are not detectable for the UE 1 at all.

Perception of car surroundings is key for advanced driver assistance systems (ADAS) and automated driving. These systems use sensing systems including radar, lidar, camera, and ultrasound sensors. Unfortunately, automotive radar systems create mutual interference, which may influence the detection quality of the SSBs.

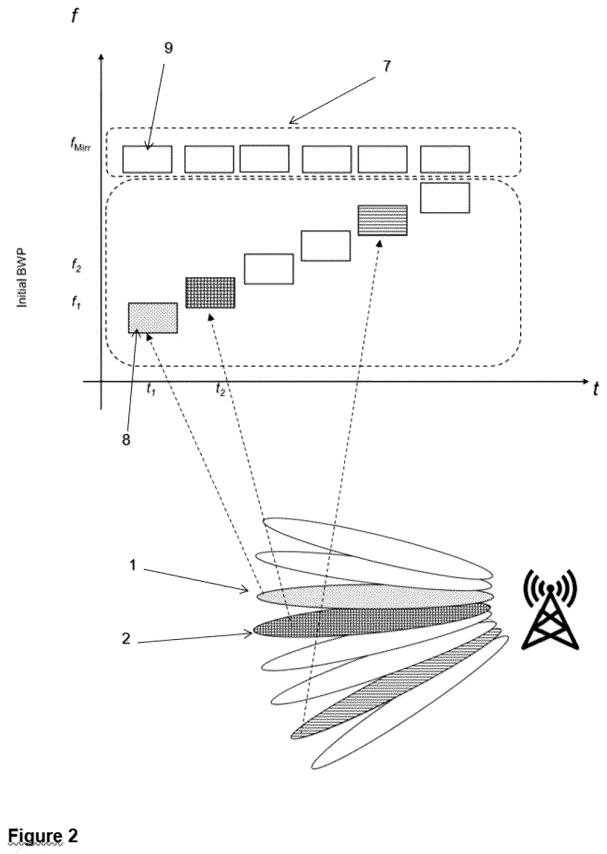

FIG. 2 illustrates the ROs of the mentioned SSBs 1, 2 and 3 in their respective time and frequency domain (f₁/t₁ and f₂/t₂). As could be seen from the diagram, each SSB has its own RO in a characteristic time (t) and frequency (f) domain. Besides there are mirror ROs 7 in a special mirror frequency domain (f_{Mirr}). which are indicated by gNB 3 as System Information. Thereby the mirror ROs are defined as a frequency resource matching the nominal RACH Occasion of each SSBs. From UE perspective, mirror ROs can be used to send the (marked) preamble using any beam except the nominal one defined at that time slot.

In the current example, the SSBs which can be used by UE for random access have indexes 1, 2, and 3. The respective index determines the RO. Up to Rel. 17 there are fixed (nominal) RACH Occasions for each SSBs. Knowing the SSB index, UE knows what RO needs to be used. In the current example, UE may use the nominal RO 8 for submitting the predefined preamble in case of selecting SSB 1 for random access. Parallel UE submits the preconfigured preamble in the mirror RO 9 which is different to nominal RO 8 but defined in the same time slot but with a different frequency f_{Mirr}. Thereby gNB indicates as system information the existence and/or the location of the mirror RO defined within the initial Bandwidth Part (BWP) but in its own frequency resource matching the nominal RO of the respective SSB. From UE perspective, mirror RO is used to send the (marked) preamble using any beam except the nominal one defined at that time slot. With that, UE may send parallel MSG-1 on number M of multiple beams.

In this example, UE monitors the whole cycle (all beams) and finds no SSB above TH_{C}, then UE transmits the preamble at t₁ in f₁ using the beam SSB=1 and in mirror RO with f_{Mirr} using the beam SSB=2 or transmit the preamble at t₂ in f₂ using the beam SSB=2 and in mirror RO with f_{Mirr} using the beam SSB=1.

The preambles used for this operation are pre-configured, thus the gNB knows that when detecting such preambles in any nominal RO, that preamble is also transmitted in the mirror RO. This has the benefit of better ability to detect such preambles, which are by definition transmitted in weak beams. This is because of diversity, and knowing the preambles that appear in the mirror RO (if detected in the nominal RO) allows interference cancellation of other concurrent preambles.

Although out-of-scope of this idea, the transmission of MSG2 could be enhanced by the gNB knowing that a one of such pre-configured preambles has been used.

As per 3GPP TS 38.331 (v17.1.0, Sec. 5.2.1) the SIB1 is transmitted on the DL-SCH with a periodicity of 160 ms and variable transmission repetition periodicity within 160 ms as specified in TS 38.213 [13], clause 13. The default transmission repetition periodicity of SIB1 is 20 ms but the actual transmission repetition periodicity is up to network implementation. For SSB and CORESET (COntrol REsourceSET) multiplexing pattern 1, SIB1 repetition transmission period is 20 ms. For SSB and CORESET multiplexing pattern 2/3, SIB 1 transmission repetition period is the same as the SSB period (TS 38.213 [13], clause 13). SIB1 includes information regarding the availability and scheduling (e.g., mapping of SIBs to SI message, periodicity, SI-window size) of other SIBs with an indication whether one or more SIBs are only provided on-demand and, in that case, the configuration needed by the UE to perform the SI request. SIB1 is cell-specific SIB.

As mentioned, UE has a certain rule (e.g., table, formula) that tells how many parallel beams (M) to use to transmit the MSG1 based on the quality of the received ones. Thus, a mapping of the form of M=f(N, TH₀) is implemented at UE side, in dependency of a threshold TH₀ and the variable N corresponding to the number of SSBs with a power between TH_{S} and TH₀, whereby TH_{S} is the minimum power where detection is possible and TH₀ is defined by the system, whereby TH_{S}≤TH₀<TH_{C}.

In the current example assume, that UE observes the following:

| SSB > TH | TH | N |
|---|---|---|
| 1, 2 | TH₀ | 2 |
| 3 | TH_{S} | |

That means, SSB=1 and SSB=2 are above TH₀ and SSB=3 is detected but below TH₀, therefore N=2. N corresponds to the number of beams, which are below TH_{C} but above TH₀. Therefore, in this example N is not a given parameter but a variable to be checked. M on the other hand is the number of parallel beams to be used. In the current case, M results to be 2, because only 2 out of the 3 detected beams (between TH_{C} and TH_{S}) are above TH₀. So, in that case Mis equal to N.

But could be different as well, if N is defined as the “N best beams” between TH_{C} and TH₀. In this alternative definition, N is not a function of TH₀ but a fixed input parameter at UE side. For example, if N=4 and UE observes only 2 beams between TH_{C} but above TH₀, M would be 2 (M≠N), but if UE observes for example 5 beams between TH_{C} but above TH₀, the M would be 4 (M=N).

The parameters TH₀ and/or N can be either given by system information or pre-coded in the specification. Besides, there may be a library or a catalog of formulas or rules, and the network indicates which one to be used.

A natural example would be: M=f (N, TH_{C,dB}−K_{dB})=N−A, with 0≤A<N whereby A is an integer and K_{dB}∈(TH_{S,dB}, TH_{C,dB}). It can be assumed that M=f(N, TH₀=TH_{C,dB}−2)=N. With that, UE will send MSG1 in the beams above TH_{C,dB}−2, i.e., M=N. The gain is 2 dB.

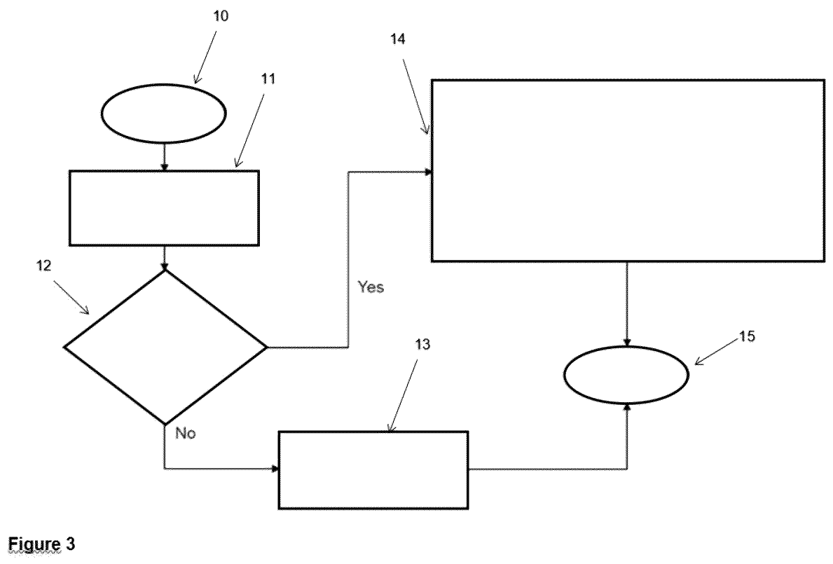

FIG. 3 is a flow chart showing mains steps of a state machine suitable to proceed parallel MSG-1 on multiple beams on UE-side. At the beginning 10, UE monitors all reachable SSBs 11. In step 12 it is checked, whether all SSBs are below network configured threshold TH. If “No” the random access behavior as known in the art is going to be proceeded. If “Yes”, in 14 the steps of determining M per implementation rule, selecting a pre-configured preamble and transmitting MSG1 the preamble in the selected beams. After that, the method on UE side is terminated 15.

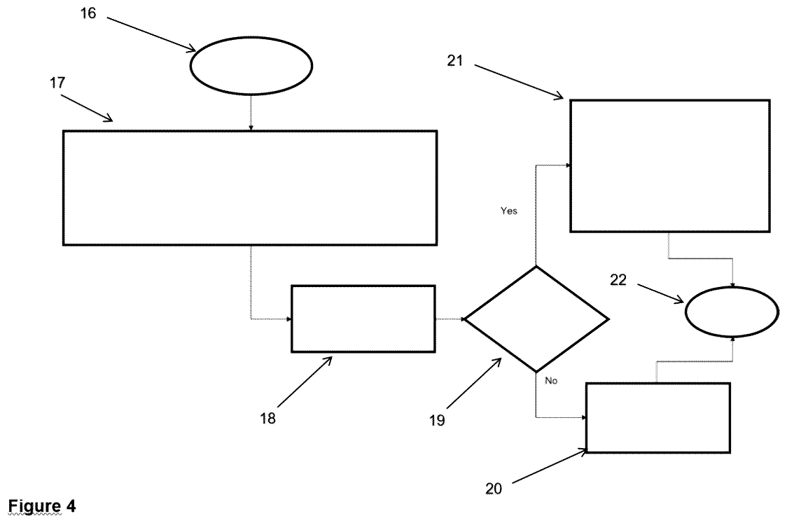

FIG. 4 is a flow chart showing mains steps of a state machine suitable to proceed parallel MSG-1 on multiple beams on gNB-side 16. In first step 17 gNB 16 Indicates in system Information including mirror frequency f_{Mirr} of mirror RO resources and a set of pre-preambles to be used for the proposed parallel RACH. In step 18, gNB monitors nominal and mirror ROs. If in 19 gNB detects an RO it checks, whether the preamble is a preconfigured preamble. In case of “No” gNB continues in the prior art manner at 20. In case of “Yes”, gNB detects mirror RO in 21 before ending the procedure at 22 with granting UE access.

In the examples above, user equipment may be referred as a mobile station, a wireless terminal, or the like. In some examples, user equipment may be a cellular phone, a wireless modem, a wireless communication device, a handheld device, a laptop computer or the like. User equipment may also be an IoT (internet of things) device, like wireless camera, a smart sensor or smart meter, a vehicle, a global positioning system device, or any other device configured to communicate through a wireless network.

Base station, especially gNB, may comprise a channel quality sensor. The channel quality sensor may be configured by computer program instructions to measure the signal strength on one or more available SSBs (Synchronization Signal Blocks), and to compare the measured values to a preconfigured threshold to determine whether all SSB's RSRP are below said threshold value.

1. A method to perform random access of a mobile user equipment (UE) to a wireless communication network especially according to 5G standard, especially when working in frequency bands above 24 GHZ, whereby the UE monitors the quality, especially the received power (RSRP), of Synchronization Signal Blocks (SSBs) and selects an SSB with quality above a network configured threshold THC for transmitting a preamble in a corresponding nominal RACH Occasion (RO) using the respective beam, characterized in that in case the UE could not find an SSB with quality above the threshold THC, the UE selects an SSB with quality below THC for transmitting a preamble in a corresponding (nominal) RACH occasion (RO) using the respective beam and selects an additional SSB for transmitting the preamble in a “mirror” RACH occasion located on a “mirror” frequency of a different beam.

2. The method according to claim 1, characterized, in that the location of mirror RO is indicated by gNB as System Information and is defined as a frequency resource within the initial Bandwidth Part matching the nominal RACH Occasion of each SSB.

3. The method according to claim 1, whereby, the preamble used in case of no SSB is found by UE with power above THC is a pre-configured (marked) preamble signaled/indicated by the base station (gNB) so that the preamble is also transmitted in the mirror RO.

4. The method according to claim 1, characterized in that the UE uses mirror ROs to send the preamble using any beam except the nominal one defined at that time slot.

5. The method according to claim 1, characterized in that M multiple beams are transmitted at the same time by using beamforming.

6. The method according to claim 5, characterized in, that M is defined by a rule implemented in the UE.

7. The method according to claim 6, characterized in that a rule defines M=f (N, TH0), that is, in dependency of a threshold TH0 and the variable N corresponding to the number of SSBs with a power between THS and TH0, whereby THS is the minimum power where detection is possible and TH0 is defined by the system, whereby THS≤TH0<THC.

8. The method according to claim 7, characterized in that the values of TH0 and/or N are given by the system information or are hard-coded in the specification.

9. The method according to claim 1, characterized in that the gNB determines to use part of the radio spectrum originally assigned for wireless communications for radar usage, especially the radio band of 400 MHz.

10. A user equipment (UE) suitable to perform random access to a communication network especially according to 5G standard, especially when working in frequency bands above 24 GHZ, characterized by a wireless transceiver, a processor coupled with a memory in which computer program instructions are stored, said instructions being configured for selecting SSB with quality below a threshold THC and for transmitting a preamble in a corresponding (nominal) RACH occasion (RO) using the respective beam and for selecting an additional SSB for transmitting the preamble in a “mirror” RACH occasion located on a “mirror” frequency of a different beam.

11. The user equipment according to claim 10, characterized by an implemented rule defining M which is the number of beams for transmission at the same time by using beamforming.

12. The user equipment according to claim 11, characterized in that the rule defines M=f (N, TH0), that is, in dependency of a threshold TH0 and the variable N corresponding to the number of SSBs with a power between THS and TH0, whereby THS is the minimum power where detection is possible and TH0 is defined by the system, whereby THS≤TH0<THC.

13. A method executed by a base station, especially by a gNB, for providing the possibility of random access to a mobile user equipment (UE) to a wireless communication network especially according to 5G standard, especially when working in frequency bands above 24 GHz, whereby the base station transmits Synchronization Signal Blocks (SSBs) with corresponding RACH Occasions (RO), characterized in that the base station indicates as System Information the location of “mirror” RACH occasions located on a “mirror” frequencies for receiving preambles.

14. The method according to claim 13, characterized in that the base station indicates preconfigured preambles to be transmitted in case of random access using mirror RACH occasions.

15. The method according to claim 13, characterized in that the base station indicates the location of mirror RO as a frequency resource within the initial Bandwidth Part (BWP) matching the nominal RACH Occasion of each SSB.

16. A base station suitable to grant random access to user equipment especially according to 5G standard, especially when working in frequency bands above 24 GHz, comprising a wireless transceiver, a processor coupled with a memory in which computer program instructions are stored, said instructions being configured to perform operations comprising:
transmitting, by the base station, Synchronization Signal Blocks (SSBs) with corresponding RACH Occasions (RO), characterized in that the base station indicates as System Information the location of “mirror” RACH occasions located on a “mirror” frequencies for receiving preambles.
